(19) United States
(12) Patent Application Publication
(10) Pub. No.: US 2015/0331492 A1
(43) Pub. Date: Nov. 19, 2015

(54) METHOD AND APPARATUS FOR IDENTIFYING SPATIAL GESTURE OF USER

(71) Applicant: SAMSUNG ELECTRONICS CO., LTD., Suwon-si (KR)

(72) Inventors: Jooyeon WOO, Hwaseong-si (KR); Eric Hyunsurk RYU, Hwaseong-si (KR); Chang Woo SHIN, Hwaseong-si (KR)

(73) Assignee: SAMSUNG ELECTRONICS CO., LTD., Suwon-si (KR)

(21) Appl. No.: 14/669,906

(22) Filed: Mar. 26, 2015

(30) Foreign Application Priority Data
May 14, 2014 (KR) 10-2014-0057884

(51) Int. Cl. G06F 3/01; G06K 9/00

(52) U.S. Cl. CPC G06F 3/017; G06K 9/00268

(57) ABSTRACT

Provided is a method and apparatus for identifying a spatial gesture of a user that may recognize a reference image of a user from a three-dimensional (3D) space in which a gesture of the user is performed, divide the 3D space into a plurality of partitioned spaces based on the reference image, and identifies the gesture of the user in the plurality of partitioned spaces, based on the reference image.

### CROSS-REFERENCE TO RELATED APPLICATION

This application claims priority from Korean Patent Application No. 10-2014-0057884, filed on May 14, 2014 in the Korean Intellectual Property Office, the disclosure of which is incorporated herein by reference in its entirety.

### BACKGROUND

1. Field

Methods and apparatuses consistent with exemplary embodiments relate to a method and apparatus for identifying a spatial gesture of a user.

2. Description of the Related Art

With respect to a two-dimensional (2D) display having a touch-based interface, a user may directly touch a menu icon displayed on the 2D display to execute a desired application. The touch-based interface is a highly reliable user interface (UI) in that the 2D display senses a touch on the display to recognize the user's intended input.

A gesture performed by the user in a three-dimensional (3D) space may also be used to deliver an intended input of the user to a device. The gesture performed by the user in the 3D space may be performed without a touch of the display. In that regard, there is a need for 3D gesture recognition that considers a posture or surrounding environment of the user to accurately identify the 3D gesture.

### SUMMARY

Exemplary embodiments may address at least the above problems and/or disadvantages and other disadvantages not described above. Also, the exemplary embodiments are not required to overcome the disadvantages described above, and an exemplary embodiment may not overcome any of the problems described above.

According to an aspect of an exemplary embodiment, there is provided a method of identifying a spatial gesture including: recognizing a reference image of a user from a three-dimensional (3D) space in which a gesture of the user is performed; dividing the 3D space into a plurality of partitioned spaces based on the reference image; and identifying the gesture of the user in the plurality of partitioned spaces, based on the reference image.

The dividing may include disposing the reference image of the user at a reference position of the 3D space; and dividing the 3D space into the plurality of partitioned spaces around the reference image.

The reference image may comprise a facial image or a upper body image of the user that performs the gesture.

When the reference image includes the facial image, the dividing may include setting a forehead portion of the facial image as a top of the 3D space, and setting a chin portion of the facial image as a bottom of the 3D space.

The identifying may include identifying a size, a position, a direction, and a depth of the gesture based on the reference image of the user in the plurality of partitioned spaces.

The identifying may include recognizing a size, a position, a direction, and a depth of the gesture, based on a motion and a shape of a portion of an upper body of the user in the plurality of partitioned spaces and a face of the user in the plurality of partitioned spaces, wherein the upper body and the face are recognized in the reference image; and identifying the gesture of the user based on the recognized size, the recognized position, the recognized direction, and the recognized depth.

The identifying may include identifying, as identical gestures, gestures matching each other in terms of the recognized size, the recognized position, the recognized direction, and the recognized depth.

The identifying may include identifying, as identical gestures, gestures starting and ending in identical spaces among the plurality of partitioned spaces.

The identifying may include identifying the gesture of the user by normalizing a size and a direction of the gesture based on a size and an orientation of the reference image.

The method may further include configuring a spatial coordinate system with respect to the plurality of partitioned spaces, wherein the identifying may comprise identifying the gesture using the configured spatial coordinate system with respect to the plurality of partitioned spaces.

An axial direction of the spatial coordinate system may be set or modified based on a shape of a face, an orientation of the face of the user, or a direction of an upper body of the user, wherein the face and the upper body are recognized in the reference image.

Sizes of the plurality of partitioned spaces may be adaptively adjusted based on a size of the reference image.

The sizes of the plurality of partitioned spaces may be relatively adjusted based on a change in the size of the reference image with respect to a distance between the user and an apparatus for identifying the gesture of the user.

Positions of the plurality of partitioned spaces may be relatively adjusted based on an orientation of the reference image.

The method may further include performing a preset function corresponding to the identified gesture of the user.

The preset function may include at least one of a function to move to a preset menu or content corresponding to the gesture of the user, a function to activate a preset gesture mode corresponding to the gesture of the user, a function to execute, terminate, lock, and unlock a preset program corresponding to the gesture of the user, and a function to authenticate the user.

According to an aspect of another exemplary embodiment, there is provided a non-transitory computer-readable recording medium which stores a program to implement a method of identifying a spatial gesture, the method including recognizing a reference image of a user from a three-dimensional (3D) space in which a gesture of the user is performed; dividing the 3D space into a plurality of partitioned spaces based on the reference image; and identifying the gesture of the user in the plurality of partitioned spaces, based on the reference image.

According to an aspect of another exemplary embodiment, there may be provided an apparatus including a detector configured to detect a reference image of a user from a three-dimensional (3D) space in which a gesture of the user is performed; and a processor configured to divide the 3D space into a plurality of partitioned spaces based on the reference image, and to identify the gesture of the user in the plurality of partitioned spaces based on the reference image.

The processor may be further configured to recognize a size, a position, a direction, and a depth of the gesture, based on a motion and a shape of a portion of an upper body of the user in the plurality of partitioned spaces, and a face of the user in the plurality of partitioned spaces, wherein the upper body and the face are recognized in the reference image; and identify the gesture of the user based on the recognized size, the recognized position, the recognized direction, and the recognized depth.

The processor may be further configured to form a spatial coordinate system with respect to the plurality of partitioned spaces, and identify the gesture using the spatial coordinate system with respect to the plurality of partitioned spaces.

The apparatus may further include a memory configured to store a preset gesture corresponding to a plurality of functions.

### BRIEF DESCRIPTION OF THE DRAWINGS

The above and/or other aspects will become more apparent and readily appreciated from the following detailed description of certain exemplary embodiments, taken in conjunction with the accompanying drawings of which:

FIG. 1 is a flowchart which illustrates a method of identifying a spatial gesture according to an exemplary embodiment;

FIG. 2 illustrates a method of identifying a relative spatial position with respect to an orientation of the face of a user by an apparatus for identifying a spatial gesture according to an exemplary embodiment;

FIG. 3 illustrates relative sizes of spaces with respect to a size of the face of a user recognized by an apparatus for identifying a spatial gesture according to an exemplary embodiment;

FIG. 4 is a flowchart which illustrates a method of identifying a spatial gesture according to another exemplary embodiment;

FIG. 5 illustrates examples of a reference position at which the face of a user is disposed in a 3D space by an apparatus for identifying a spatial gesture according to an exemplary embodiment;

FIG. 6 illustrates gestures identified as identical gestures by an apparatus for identifying a spatial gesture according to an exemplary embodiment;

FIG. 7 illustrates gestures identified as different gestures by an apparatus for identifying a spatial gesture according to an exemplary embodiment;

FIG. 8 illustrates gestures identified as identical gestures by an apparatus for identifying a spatial gesture according to another exemplary embodiment;

FIG. 9 illustrates gestures identified as different gestures by an apparatus for identifying a spatial gesture according to another exemplary embodiment;

FIG. 10 is a flowchart which illustrates a method of identifying a spatial gesture according to still another exemplary embodiment;

FIG. 11 illustrates a method of identifying a gesture of moving through different partitioned spaces by an apparatus for identifying a spatial gesture according to an exemplary embodiment;

FIG. 12 illustrates a method of identifying a gesture performed using two hands in different partitioned spaces by an apparatus for identifying a spatial gesture according to an exemplary embodiment; and

FIG. 13 is a block diagram which illustrates an apparatus for identifying a spatial gesture according to an exemplary embodiment.

### DETAILED DESCRIPTION

Exemplary embodiments are described in detail below with reference to the accompanying drawings, wherein like reference numerals refer to the like elements throughout.

Though the inventive concept may be variously modified and have several embodiments, specific embodiments will be shown in drawings and be explained in detail. However, the inventive concept is not meant to be limited, but it is intended that various modifications, equivalents, and alternatives are also covered within the scope of the claims.

Terms used herein are to merely explain certain embodiments, not meant to limit the scope of the inventive concept. A singular expression includes a plural concept unless there is a contextually distinctive difference therebetween. In this description, the term “include” or “have” is intended to indicate that characteristics, numbers, steps, operations, components, elements, etc. disclosed in the specification or combinations thereof exist. As such, the term “include” or “have” should be understood that there are additional possibilities of one or more other characteristics, numbers, steps, operations, components, elements or combinations thereof.

Unless specifically defined, all the terms used herein including technical or scientific terms have the same meaning as terms generally understood by those skilled in the art. Terms defined in a general dictionary should be understood so as to have the same meanings as contextual meanings of the related art. Unless definitely defined in the present invention, the terms are not interpreted as ideal or excessively formal meanings.

Hereinafter, the terms “spatial gesture” and “gesture” may be used interchangeably.

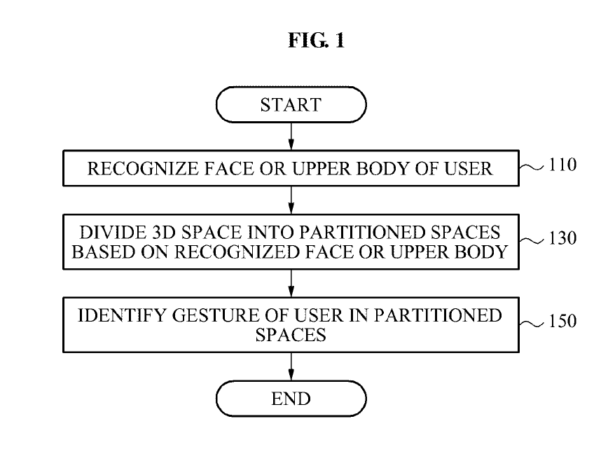

FIG. 1 is a flowchart which illustrates a method of identifying a spatial gesture according to an exemplary embodiment.

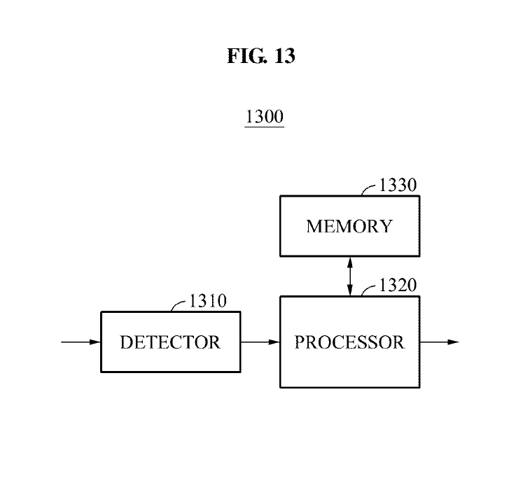

Referring to FIG. 1, an apparatus for identifying a spatial gesture (hereinafter referred to as “identifying apparatus”) may recognize a user's face or upper body in operation 110. The identifying apparatus may recognize the face or upper body using a detector (e.g., see a detector 1310 of FIG. 13), such as, for example, a motion detection sensor and an image sensor. The upper body may refer to a body area including the face, neck, and shoulders of the user.

The identifying apparatus may recognize a gesture of the user including the user's face or upper body within a predetermined angle and a predetermined distance from the detector.

The identifying apparatus may be implemented using devices including a detector, for example, home appliances such as, for example, a television (TV), a refrigerator, a washing machine, and a computer, mobile terminals, or communication devices having a similar function.

In operation 130, the identifying apparatus may divide a three-dimensional (3D) space in which the gesture of the user is performed into a plurality of partitioned spaces based on the recognized face or upper body of the user.

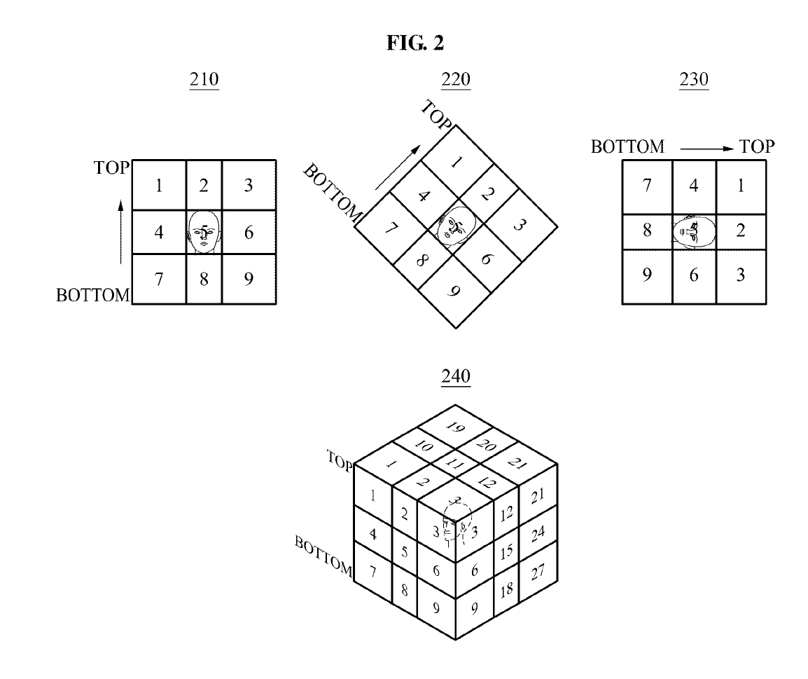

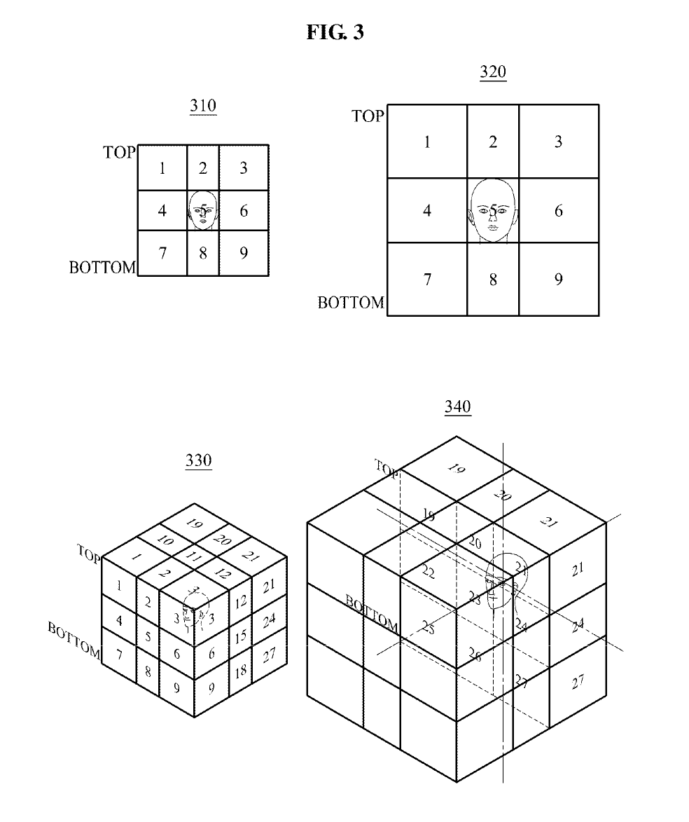

FIGS. 2 and 3 show a method of disposing a recognized facial image of a user at a reference position of the 3D space and dividing the 3D space into the plurality of partitioned spaces by the identifying apparatus.

Herein, a method of dividing a 3D space into a plurality of partitioned spaces is described based on the facial image merely for convenience, and are not to be construed as being limited to the facial image. Any body part of the user may be used as a criterion to divide the 3D space into the plurality of partitioned spaces. The criterion body part may correspond to any body part such as, for example, the eyes, trunk, and chest of the user. The identifying apparatus may partition the 3D space into spaces and set an orientation of the 3D space to place the user's forehead or eyes upper than the chin or lips in the 3D space.

In an exemplary embodiment, a space around the user may be divided into a plurality of partitioned spaces based on that a movement of a gesture changes relatively little around the face or upper body of the user.

In an exemplary embodiment, a highly reliable user interface (UI) may be implemented by identifying a spatial gesture of a user based on a form of a gesture input, and a ratio of a size of the gesture to a size of a body part of the user, for example, the user's face, in recognized images.

Sizes of the plurality of partitioned spaces may be adaptively adjusted based on the size of the facial image. The sizes of the plurality of partitioned spaces may be relatively adjusted based on a change in the size of the facial image with respect to a distance between the user and the identifying apparatus such as, for example, a TV. Positions of the plurality of partitioned spaces may be relatively adjusted based on the orientation of the user's face or upper body.

In operation 150, the identifying apparatus may identify the gesture of the user in the plurality of partitioned spaces.

The identifying apparatus may identify a size, a position, a direction or an orientation, and a depth of the gesture based on the facial image in the plurality of partitioned spaces.

The identifying apparatus may identify the gesture of the user based on a motion and a shape of a portion of the upper body of the user, and a size, a position, a direction, and a depth of the gesture based on the facial image in the plurality of partitioned spaces.

FIG. 2 illustrates a method of identifying a relative spatial position with respect to an orientation of a user's face by an identifying apparatus according to an exemplary embodiment.

FIG. 2 shows a plurality of partitioned spaces divided by the identifying apparatus. The identifying apparatus may divide a 3D space into the plurality of partitioned spaces based on a recognized facial image of the user.

As shown in an image 210, the identifying apparatus may divide a 3D space into nine spaces based on the facial image, number the spaces starting from an upper left space to the right, and set the facial image to be disposed in space 5. The identifying apparatus may set the facial image as the center of enlargement, and expand spaces which are disposed on the left and right sides of the facial image. In this example, positions of the expanded spaces may change based on an orientation of the facial image.

The identifying apparatus may set a size of space 5 to be similar to a size of the facial image, and enlarge sizes of remaining spaces to the outside so that the sizes of the remaining spaces are to be 1.5 times greater than the size of the facial image. In this example, an axial direction of a spatial coordinate system with respect to the plurality of partitioned spaces may be set based on a shape of the user's face, the orientation of the user's face, or an orientation of the user's upper body.

When the orientation of the user's face recognized by the identifying apparatus corresponds to a horizontal orientation, the identifying apparatus may divide the 3D space in which the gesture of the user is performed into horizontally partitioned spaces based on the facial image, as shown in image 210.

When the user's face recognized by the identifying apparatus tilts at an angle of 45 degrees) (° to the right, the identifying apparatus may divide the 3D space in which the gesture of the user is performed into partitioned spaces tilting at an angle of 45° to the right based on the facial image, as shown in image 220. When the user's face recognized by the identifying apparatus tilts at an angle of 90° to the right, the identifying apparatus may divide the 3D space in which the gesture of the user is performed into partitioned spaces tilting at an angle of 90° to the right based on the facial image, as shown in image 230.

In images 210 through 230, the identifying apparatus is described as dividing a plane into nine planes parallel to a surface of the facial image to accommodate better understanding. However, all of the plurality of partitioned spaces divided by the identifying apparatus may refer to 3D spaces having sizes of width x height x depth, as shown in image 240.

The identifying apparatus may dispose the facial image at a reference position of the 3D space. The reference position of the 3D space may correspond to, for example, a central portion of a cube as shown in image 330 of FIG. 3, or a bottom surface of a central portion of a cube as shown in image 340. In addition, the reference position of the 3D space may vary depending on user settings.

Although the identifying apparatus may partition the 3D space into 3×3×3 spaces based on the facial image, sizes or forms of the partitioned spaces divided by the identifying apparatus are not limited thereto. The identifying apparatus may dispose the facial image at the reference position of the 3D space, and divide the 3D space into a plurality of partitioned spaces having various forms, for example, 3×1×3, 1×1×2, 5×5×5, 5×5×3, or 5×3×2.

FIG. 3 illustrates relative sizes of spaces with respect to a size of a recognized facial image of a user recognized by an identifying apparatus according to an exemplary embodiment.

As shown in FIG. 3, the sizes of the spaces are relatively adjusted based on a change in the size of the facial image with respect to a distance between the identifying apparatus and the user.

The identifying apparatus may relatively adjust sizes of a plurality of partitioned spaces based on the change in the size of the facial image with respect to the distance from the user.

For example, in images 310 and 320, the identifying apparatus may adaptively adjust sizes of spaces in which a gesture of the user is performed based on a corresponding size of the facial image, and perform partitioning.

For example, the size of the facial image recognized by the identifying apparatus may correspond to 3 cm×3 cm. The identifying apparatus may partition and divide, around the facial image, a 3D space in which a gesture of the user is performed into spaces having widths, heights, and depths 1.5 times greater than the size of the facial image. In detail, the identifying apparatus may divide the 3D space, around the facial image, into a plurality of partitioned spaces having widths, heights, and depths of 4.5 cm.

When the size of the facial image corresponds to 3.5 cm×4 cm×3.5 cm, the identifying apparatus may divide the 3D space into a plurality of partitioned spaces having widths of 3.5 cm×1.5=5.25 cm, heights of 4 cm×1.5=6 cm, and depths of 3.5 cm×1.5=5.25 cm.

The identifying apparatus may identify the gesture of the user by normalizing a size and a direction of the gesture based on a size and an orientation of the facial image.

For example, if a size of a gesture of holding an arm in the air is recognized as 4 cm when the size of the facial image is 2 cm×3 cm, an 8 cm gesture of holding an arm in the air may be identified as the same gesture as the 4 cm gesture, provided that the size of the facial image corresponds to 4 cm×6 cm.

In addition, the identifying apparatus may verify whether a gesture of the user performed in a second state is identical to a gesture performed in a first state, by normalizing a size of a recognized facial image of the user, an orientation of the facial image, and the gesture performed by the user in the first state.

For example, the user may perform a gesture of stretching the right arm forward and clenching a fist in a second state in which the user is watching TV lying on a side with the head rested on the left arm. Information on a gesture of stretching the right arm forward and clenching a fist in a first state in which the user is sitting may be prestored in a memory of the identifying apparatus.

When the user performs the same gesture performed in the first state, in the second state, the identifying apparatus may verify whether the two gestures are identical based on a size and an orientation of a recognized facial image of the user.

An axial direction of a spatial coordinate system with respect to the 3D space in which the gesture of the user is performed may be set or modified based on a shape or an orientation of the user's face or an orientation of the user's upper body. The identifying apparatus may verify whether the user is sitting, lying, or leaning, and modify the axial direction of the spatial coordinate system.

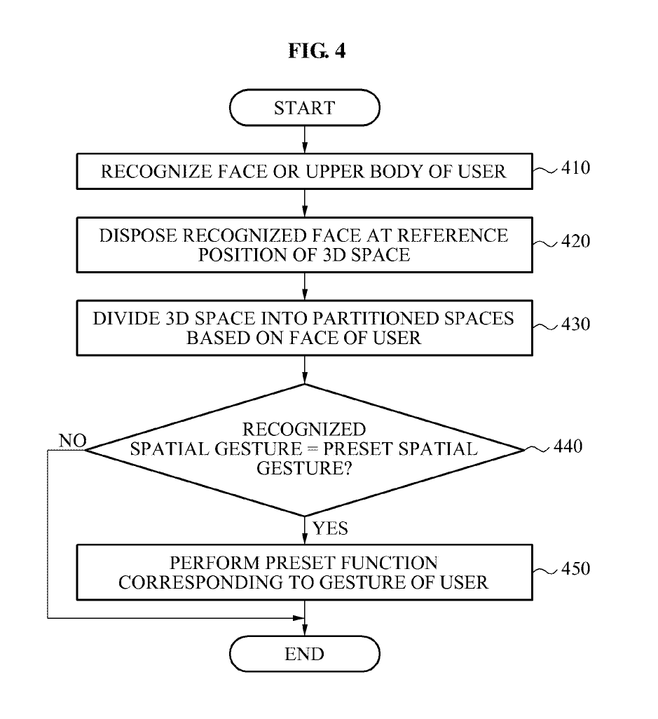

FIG. 4 is a flowchart which illustrates a method of identifying a spatial gesture according to another exemplary embodiment.

As shown in FIG. 4, an identifying apparatus may recognize the face or upper body of a user in operation 410.

In operation 420, the identifying apparatus may dispose a recognized facial image of the user at a reference position of a 3D space.

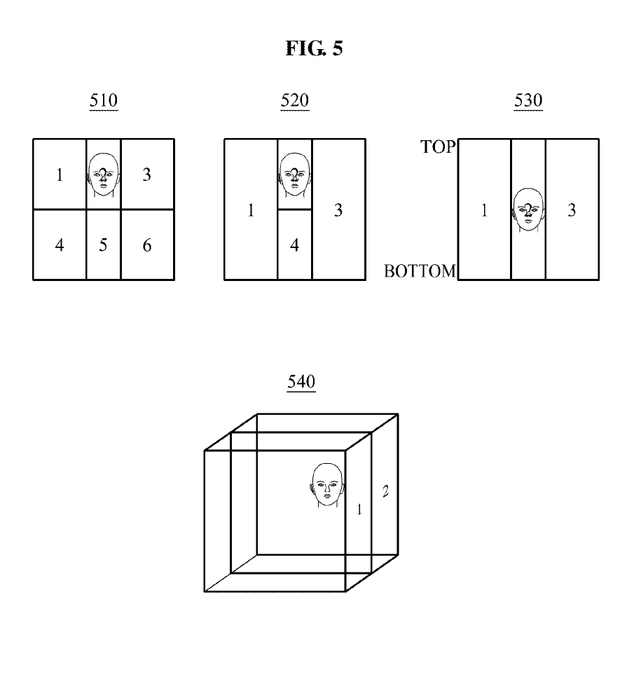

The identifying apparatus may dispose the facial image at the reference position of the 3D space such as, for example, a central portion of a cube as shown in image 330 or a bottom surface of a central portion of a cube as shown in image 340 of FIG. 3. The reference position at which the facial image is disposed in the 3D space by the identifying apparatus will be described with reference to FIG. 5.

In operation 430, the identifying apparatus may divide the 3D space into a plurality of partitioned spaces based on the facial image disposed at the reference position of the 3D space.

In operation 440, the identifying apparatus may determine whether a recognized gesture of the user is identical to a preset gesture of the user in terms of a motion and a shape of a portion of the upper body of the user, and a size, a position, a direction, and a depth of the gesture based on the facial image in the plurality of partitioned spaces. A preset gesture of the user may be matched to, for example, a plurality of functions and stored in a memory (e.g., see a memory 1330 of FIG. 13) in a form of a table, a database, or another data structure.

The identifying apparatus may determine that the recognized gesture of the user is identical to the preset gesture of the user when the two gestures are completely identical or have a similarity of at least a predetermined level, for example, 95%, in terms of the motion and the shape of the portion of the upper body, and the size, the position, the direction, and the depth of the gesture.

When it is determined in operation 440 that the two spatial gestures are not identical in operation 440, the identifying apparatus may terminate an operation.

When it is determined in operation 440 that the two spatial gestures are identical in operation 440, the identifying apparatus may perform a preset function corresponding to the gesture of the user in operation 450.

The preset function corresponding to the gesture of the user may include, for example, a function to move to a preset menu or content corresponding to the gesture of the user, a function to activate a preset gesture mode corresponding to the gesture of the user, a function to execute, terminate, lock, and unlock a preset program corresponding to the gesture of the user, and a function to authenticate the user.

The function to activate the preset gesture mode may refer to an operation of informing the identifying apparatus of an initiation of the gesture mode in which an operation control is performed in response to the gesture of the user in advance of executing, terminating, locking, or unlocking the preset program corresponding to the gesture of the user.

For example, to operate a TV in a gesture mode, the user may perform a preset gesture to trigger an entry into the gesture mode. The user may perform the preset gesture to inform the identifying apparatus that an operation in the gesture mode is to be initiated. The identifying apparatus may perform various preset functions by tracking a gesture performed after the gesture mode is activated.

The predetermined gesture may correspond to, for example, a gesture of disposing a palm to face a TV or a computer, or a gesture of drawing a circle with a finger.

The method of identifying a gesture of a user in spaces partitioned based on a recognized facial image of a user may be used to provide a personalized service associated with a social event, a personal event, seasons, time, and personal information of the user by recognizing or authenticating the user in a shared electronic device. In addition, the method of identifying a gesture of a user in spaces partitioned based on a recognized facial image of a user may use an identified gesture as a short key with respect to various application programs. Also, the method may be used for various types of security systems requiring user recognition.

FIG. 5 illustrates examples of a reference position at which a recognized facial image of a user is disposed in a 3D space by an identifying apparatus according to an exemplary embodiment.

As shown in FIG. 5, the identifying apparatus may dispose the facial image at a reference position or in a reference space of the 3D space based on a preset value.

The identifying apparatus may dispose the facial image at the reference position or in the reference space of the 3D space based on the preset value, and set a plurality of spaces based on a size and an orientation of the facial image.

When the reference position corresponds to a top end of a central portion, for example, a position of space 2, the identifying apparatus may dispose the facial image at the position of space 2, and divide the 3D space by partitioning remaining spaces based on the facial image.

The identifying apparatus may divide a 3D space by partitioning spaces having similar sizes at a predetermined ratio based on a position of the facial image as shown in image 510 or 530, or divide a 3D space by partitioning spaces having different sizes as shown in image 520.

The identifying apparatus may divide a 3D space into two spaces in a depth direction, dispose the facial image at a horizontally and vertically central portion, and divide a single space at a predetermined ratio. The identifying apparatus may dispose the facial image at the center of space 2 in a depth direction, and divide a space in the depth direction as shown in image 540.

A size of each space may be set based on a space division ratio, for example, 3:2:1. The space division ratio may be set based on a size of the facial image. For example, when the size of the facial image corresponds to 3 cm×2 cm, the size of each space may correspond to 9 cm×4 cm×3 cm.

In the size of each space, the width of 9 cm may correspond to 3 times the width of 3 cm of the facial image, the height of 4 cm may correspond to 2 times the height of 2 cm of the facial image, and the depth of 3 cm may correspond to 1 time the width of 3 cm of the facial image.

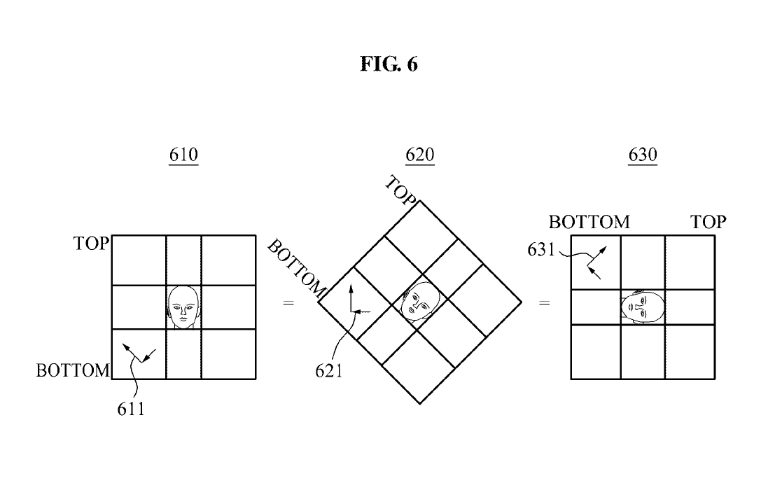

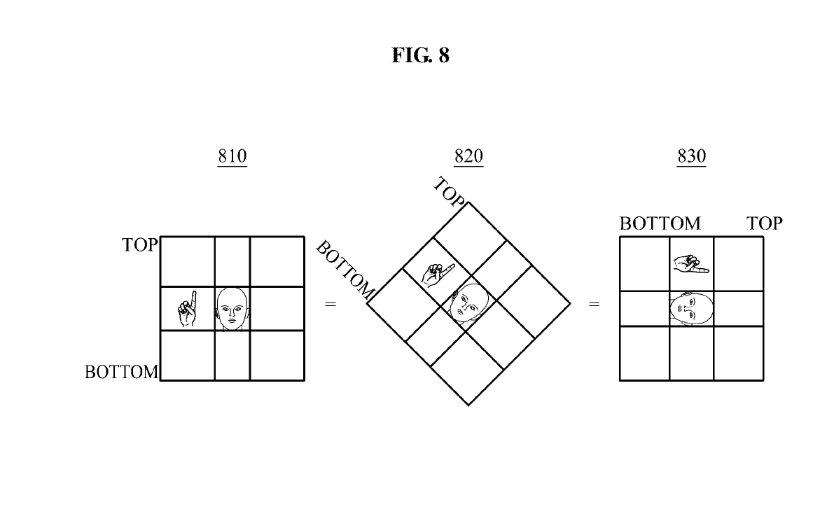

FIGS. 6 and 8 illustrate gestures identified as identical gestures by an identifying apparatus according to an exemplary embodiment.

As shown in FIGS. 6 and 8, the identifying apparatus may identify identical gestures having identical positions and directions based on a recognized facial image of a user.

The identifying apparatus may identify a size, a position, a direction, and a depth of a gesture based on the facial image in a plurality of partitioned spaces.

As shown in image 610, the user may perform a gesture of drawing a line down and then up, for example, drawing a check mark, in lower left space 611, and the identifying apparatus may recognize and store information on the corresponding gesture in relation to a position of the facial image.

When gestures of drawing a line down and then up are performed in lower left space 621 or 631 based on a position of the facial image although the facial image tilts at an angle of 45° to the right as shown in image 620 or the face of the user tilts at an angle of 90° to the right as shown in image 630, the identifying apparatus may identify the gestures as identical gestures. In this example, the “identical gestures” may refer to gestures matching in all terms of a size, a position, a direction, and a depth of a gesture in partitioned spaces.

The identifying apparatus may also identify a motion and a shape of a portion of the body of the user, for example, a hand, in the partitioned spaces.

For example, the identifying apparatus may store information on a gesture of a user pointing up with an index finger in a left space next to the facial image as shown in image 810 of FIG. 8.

When gestures of pointing up with an index finger are performed in a left space next to the facial image based on a position of the facial image although an angle of the facial image in image 820 or 830 differs from an angle of the facial image in image 810, the identifying apparatus may identify the gestures in images 810, 820, and 830 as identical gestures.

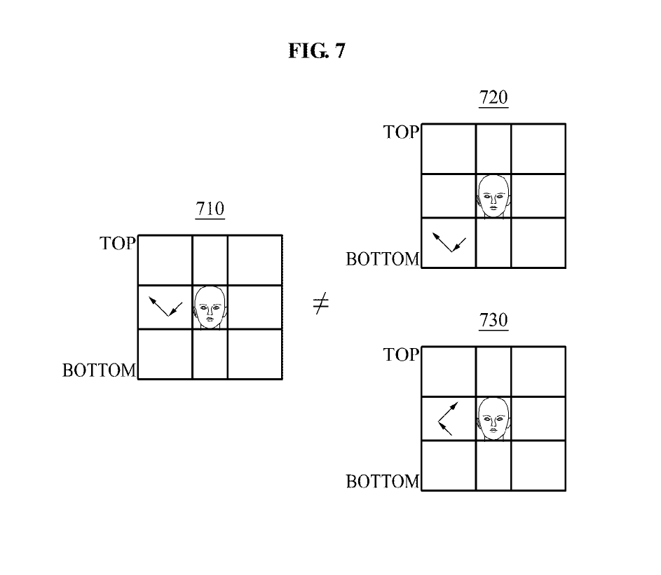

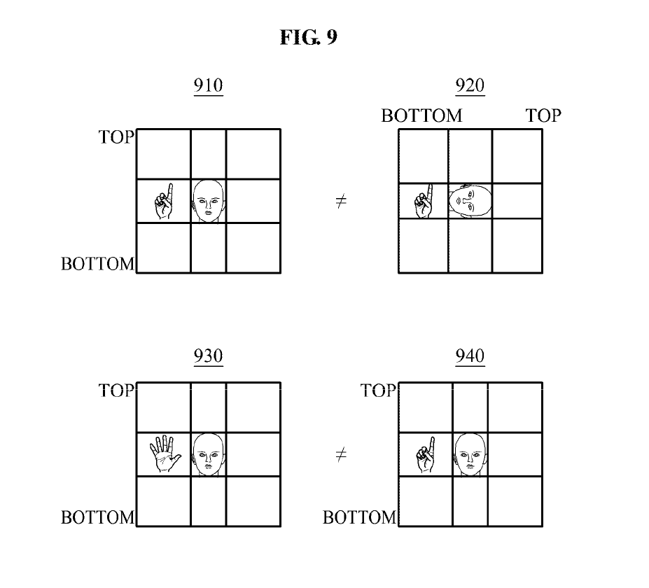

FIGS. 7 and 9 illustrate gestures identified as different gestures by an identifying apparatus according to an exemplary embodiment.

The identifying apparatus may identify gestures performed in difference spaces or gestures with different top/bottom directions as different gestures.

As shown in image 710, a user may perform a gesture of drawing a line down at an angle of 45° and then up to the outside at an angle of 90°, for example, drawing a check mark in a pattern of

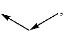

in a left space next to a face of the user.

Although the user performs the same gesture of image 710, the identifying apparatus may identify both gestures as different gestures when a space in which the gesture is performed corresponds to a lower left space as shown in image 720, rather than a left space next to the facial image.

Although a gesture of drawing a check mark is performed in a left space next to the facial image, the identifying apparatus may identify both gestures as different gestures when the gesture corresponds to a gesture of drawing a check mark in a pattern of

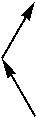

rotated at an angle of 90° to the right based on the facial image as shown in image 730.

The identifying apparatus may identify gestures differing in terms of a motion and a shape of a portion of a body of the user, for example, a hand, as different gestures.

As shown in image 910 of FIG. 9, the user may perform a gesture of pointing up with an index finger.

Although a shape of a hand in image 920 is similar to that in image 910, the identifying apparatus may identify both gestures as different gestures since the hand of the user is disposed in a space immediately below the face of the user in image 920 whereas the hand of the user is disposed on a left side of the face of the user in image 910.

The identifying apparatus may identify, as different gestures, a gesture of stretching fingers as shown in image 930 and a gesture of stretching an index finger as shown in image 940.

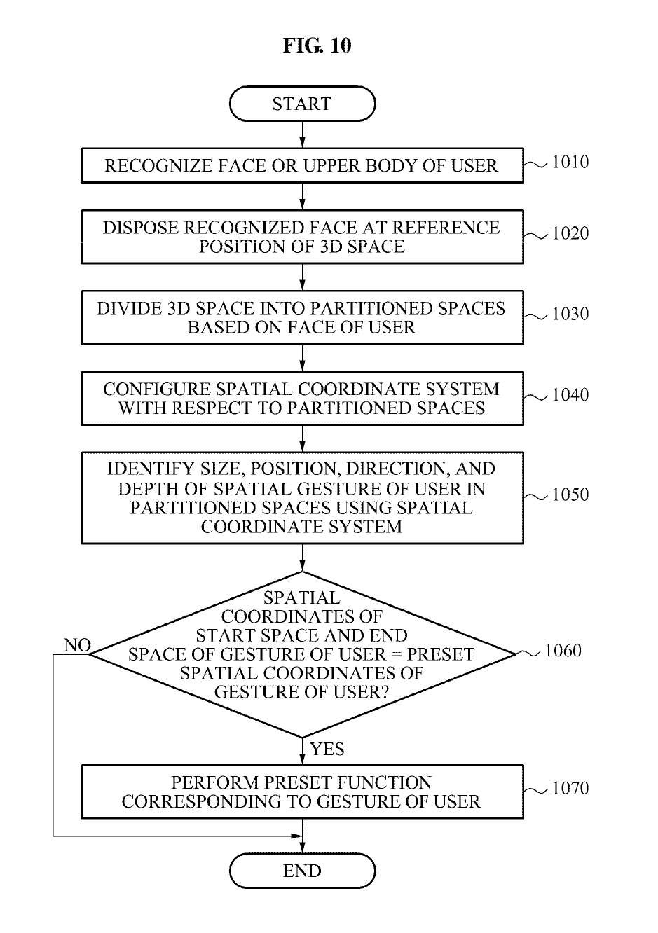

FIG. 10 is a flowchart which illustrates a method of identifying a spatial gesture according to another exemplary embodiment.

As shown in FIG. 10, an identifying apparatus may recognize the face or upper body of a user in operation 1010.

In operation 1020, the identifying apparatus may dispose a recognized facial image of the user at a reference position of a 3D space.

In operation 1030, the identifying apparatus may divide the 3D space into a plurality of partitioned spaces based on the facial image disposed at the reference position.

In operation 1040, the identifying apparatus may configure a spatial coordinate system with respect to the plurality of partitioned spaces.

In operation 1050, the identifying apparatus may identify a size, a position, a direction, and a depth of a gesture of the user in the plurality of partitioned spaces using the configured spatial coordinate system. In this example, the gesture of the user may be identified based on a position and/or orientation of the facial image in the plurality of partitioned spaces.

In operation 1060, the identifying apparatus may determine whether spatial coordinates of a start space and an end space of the gesture of the user in the plurality of partitioned spaces are identical to preset spatial coordinates of the gesture of the user.

The identifying apparatus may identify, as identical gestures, gestures starting and ending in identical spaces among the plurality of partitioned spaces.

When it is determined in operation 1060 that the spatial coordinates of the start space and the end space of the gesture of the user are not identical to the preset spatial coordinates of the gesture of the user, the identifying apparatus may terminate an operation.

When it is determined in operation 1060 that the spatial coordinates of the start space and the end space of the gesture of the user are identical to the preset spatial coordinates of the gesture of the user, the identifying apparatus may perform a preset function corresponding to the gesture of the user, in operation 1070.

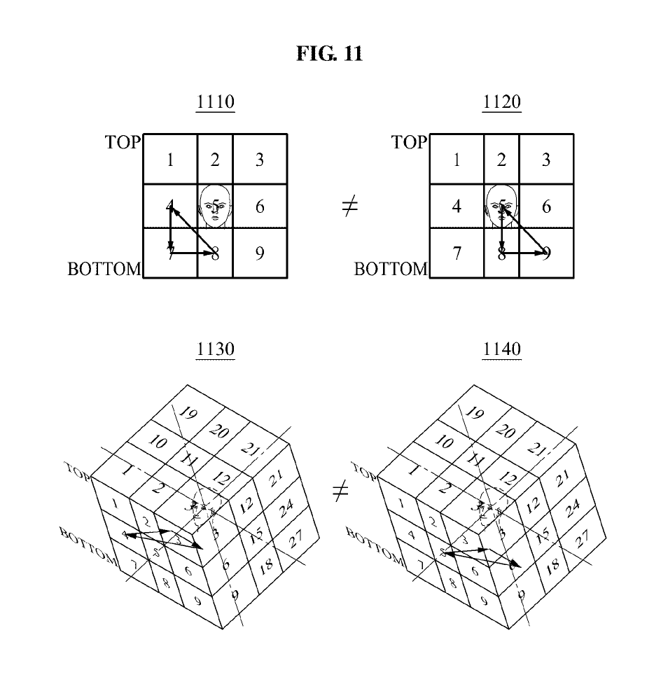

FIG. 11 illustrates a method of identifying a gesture of moving through different partitioned spaces by an identifying apparatus according to an exemplary embodiment.

Gestures identified by the identifying apparatus may include a gesture performed within a predetermined space, or a gesture of moving through different spaces. The identifying apparatus may recognize, as different gestures, gestures having different pieces of spatial movement information in a plurality of partitioned spaces.

As shown in image 1110, the user may perform a first gesture of drawing a triangle, starting from space 4 on the left of a recognized facial image of the user through spaces 7 and 8 below the facial image to the space 4. Spatial movement information of the first gesture may be expressed as “4→7→8→4”.

Although the user performs a gesture of drawing a triangle identical to the triangle of image 1110, the identifying apparatus may identify both gestures as different gestures when spatial movement information of the corresponding gesture differs from the spatial movement information of the first gesture.

For example, the user may perform a second gesture of drawing a triangle, starting from space 5 in which the face of the user is disposed through spaces 8 and 9 below the facial image to space 5, as shown in image 1120. Spatial movement information of the second gesture may be expressed as “5→8→9→5”.

The first gesture and the second gesture correspond to gestures of drawing identical triangles. However, the first gesture and the second gesture start and end in different spaces. Since the first gesture and the second gesture have different elements of spatial movement information, the identifying apparatus may identify the first gesture and the second gesture as different gestures.

The identifying apparatus may also identify a gesture based on spatial movement information provided in a 3D form as shown in images 1130 and 1140.

In image 1130, spatial movement information of a third gesture performed by the user may be expressed as “4→16→17→4”. In image 1140, spatial movement information of a fourth gesture performed by the user may be expressed as “5→17→18→5”.

Since the spatial movement information of the third gesture of image 1130 differs from the spatial movement information of the fourth gesture of image 1140, the identifying apparatus may identify both gestures as different gestures.

In the present exemplary embodiment, although gestures are provided in identical forms, spaces in which the gestures are performed may be identified. Thus, a user recognition rate may increase and various functions may be mapped to a single form of a gesture.

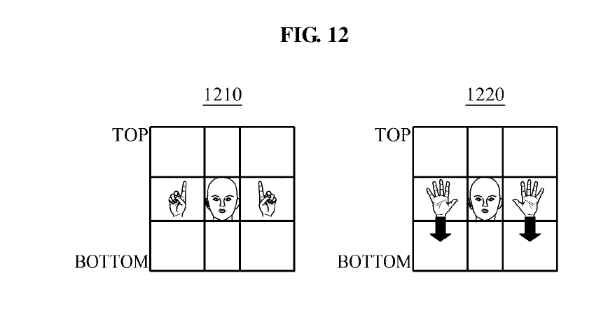

FIG. 12 illustrates a method of identifying a gesture performed using two hands in different partitioned spaces by an identifying apparatus according to an exemplary embodiment.

The identifying apparatus may identify a gesture performed using a single hand, and also identify a gesture performed using two hands simultaneously. The identifying apparatus may identify a gesture of pointing up with two hands in predetermined spaces as shown in image 1210, and a gesture of moving two hands through different spaces from top to bottom as shown in image 1220.

The identifying apparatus may recognize a user based on a combination of a size of a recognized facial image of the user, an orientation of the facial image, a shape of a hand, a size of a gesture, a position of the gesture, a form of the gesture, a number of hands, and spatial movement information.

The identifying apparatus may identify various gestures performed in a predetermined space based on the orientation and/or position of the facial image. Thus, the identifying apparatus may accurately identify a gesture of the user irrespective of directions of various postures, for example, a sitting posture and a lying posture.

FIG. 13 is a block diagram which illustrates an identifying apparatus 1300 according to an exemplary embodiment.

As shown in FIG. 13, the identifying apparatus 1300 may include the detector 1310, a processor 1320, and the memory 1330.

The detector 1310 may detect a gesture of a user including the face or upper body of the user. The upper body of the user may refer to a body area including the face, neck, and shoulders of the user.

The detector 1310 may detect a motion of the user, for example, the gesture of the user, within a predetermined angle and a predetermined distance from the identifying apparatus 1300. The detector 1310 may be configured using a motion detection sensor, and an image sensor.

The processor 1320 may divide a 3D space in which the gesture of the user is performed into a plurality of partitioned spaces based on the recognized face or upper body of the user. The processor 1320 may identify the gesture of the user in the plurality of partitioned spaces.

The processor 1320 may identify a size, a position, a direction, and a depth of the gesture of the user based on the face of the user in the plurality of partitioned spaces.

The processor 1320 may identify the gesture of the user based on a motion and a shape of a portion of the upper body of the user, and the size, the position, the direction, and the depth of the gesture based on the face of the user in the plurality of partitioned spaces.

The processor 1320 may identify, as identical gestures, gestures starting and ending in identical spaces among the plurality of partitioned spaces.

The processor 1320 may configure a spatial coordinate system with respect to the plurality of partitioned spaces, and identify the gesture of the user using the configured spatial coordinate system with respect to the plurality of partitioned spaces.

The memory 1330 may store a preset gesture of the user corresponding to a plurality of functions. The plurality of functions may be preset.

The preset plurality of functions may include, for example, at least one of a function to move to a preset menu or content corresponding to the gesture of the user, a function to activate a preset gesture mode corresponding to the gesture of the user, a function to execute, terminate, lock, and unlock a preset program corresponding to the gesture of the user, and a function to authenticate the user.

The gesture of the user may be stored in the memory 1330 in a form of a table, a database, or another data structure in which gestures of the user corresponding to a plurality of functions are recorded.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more non-transitory computer readable recording mediums.

The methods described herein may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes embodied herein, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of identifying a spatial gesture, the method comprising:
recognizing a reference image of a user from a three-dimensional (3D) space in which a gesture of the user is performed;
dividing the 3D space into a plurality of partitioned spaces based on the reference image; and
identifying the gesture of the user in the plurality of partitioned spaces, based on the reference image.

2. The method of claim 1, wherein the dividing comprises:
disposing the reference image of the user at a reference position of the 3D space; and
dividing the 3D space into the plurality of partitioned spaces around the reference image.

3. The method of claim 1, wherein the reference image comprises a facial image or an upper body image of the user that performs the gesture.

4. The method of claim 3, wherein when the reference image comprises the facial image, the dividing comprises setting a forehead portion of the facial image as a top of the 3D space, and setting a chin portion of the facial image as a bottom of the 3D space.

5. The method of claim 1, wherein the identifying comprises identifying a size, a position, a direction, and a depth of the gesture based on the reference image of the user in the plurality of partitioned spaces.

6. The method of claim 1, wherein the identifying comprises
recognizing a size, a position, a direction, and a depth of the gesture, based on a motion and a shape of a portion of an upper body of the user in the plurality of partitioned spaces and a face of the user in the plurality of partitioned spaces, wherein the upper body and the face are recognized in the reference image; and
identifying the gesture of the user based on the recognized size, the recognized position, the recognized direction, and the recognized depth.

7. The method of claim 6, wherein the identifying comprises identifying, as identical gestures, gestures matching each other in terms of the recognized size, the recognized position, the recognized direction, and the recognized depth.

8. The method of claim 1, wherein the identifying comprises identifying, as identical gestures, gestures starting and ending in identical spaces among the plurality of partitioned spaces.

9. The method of claim 1, wherein the identifying comprises identifying the gesture of the user by normalizing a size and a direction of the gesture based on a size and an orientation of the reference image.

10. The method of claim 1, further comprising:
configuring a spatial coordinate system with respect to the plurality of partitioned spaces,
wherein the identifying comprises identifying the gesture using the configured spatial coordinate system with respect to the plurality of partitioned spaces.

11. The method of claim 10, wherein an axial direction of the spatial coordinate system is set or modified based on a shape of a face, an orientation of the face of the user, or a direction of an upper body of the user, wherein the face and the upper body are recognized in the reference image.

12. The method of claim 1, wherein sizes of the plurality of partitioned spaces are adaptively adjusted based on a size of the reference image.

13. The method of claim 12, wherein the sizes of the plurality of partitioned spaces are relatively adjusted based on a change in the size of the reference image with respect to a distance between the user and an apparatus for identifying the gesture of the user.

14. The method of claim 1, wherein positions of the plurality of partitioned spaces are relatively adjusted based on an orientation of the reference image.

15. The method of claim 1, further comprising:
performing a preset function corresponding to the identified gesture of the user.

16. The method of claim 15, wherein the preset function comprises at least one of a function to move to a preset menu or content corresponding to the gesture of the user, a function to activate a preset gesture mode corresponding to the gesture of the user, a function to execute, terminate, lock, and unlock a preset program corresponding to the gesture of the user, and a function to authenticate the user.

17. A non-transitory computer-readable recording medium which stores a program which is executed by a computer to perform the method of claim 1.

18. An apparatus for identifying a spatial gesture, the apparatus comprising:
a detector configured to detect a reference image of a user from a three-dimensional (3D) space in which a gesture of the user is performed; and
a processor configured to divide the 3D space into a plurality of partitioned spaces based on the reference image, and to identify the gesture of the user in the plurality of partitioned spaces based on the reference image.

19. The apparatus of claim 18, wherein the processor is further configured to
recognize a size, a position, a direction, and a depth of the gesture, based on a motion and a shape of a portion of an upper body of the user in the plurality of partitioned spaces, and a face of the user in the plurality of partitioned spaces, wherein the upper body and the face are recognized in the reference image; and
identify the gesture of the user based on the recognized size, the recognized position, the recognized direction, and the recognized depth.

20. The apparatus of claim 18, wherein the processor is further configured to form a spatial coordinate system with respect to the plurality of partitioned spaces, and identify the gesture using the spatial coordinate system with respect to the plurality of partitioned spaces.

21. The apparatus of claim 18, further comprising:
a memory configured to store a preset gesture of the user corresponding to a plurality of functions.
